(19) United States
(12) Patent Application Publication
(10) Pub. No.: US 2026/0145364 A1
(43) Pub. Date: May 28, 2026

(54) METHOD FOR OPERATING AN EXTRUDER, COMPUTER PROGRAM, CONTROLLER, AND EXTRUDER

(71) Applicant: COPERION GMBH, Stuttgart (DE)

(72) Inventors: Markus SCHMUDDE, Steinheim a.d. Murr (DE); Johannes HEYN, Altbach (DE); Felix DREHER, Stuttgart (DE); Tanja KARRER; Stefan BRAUSAM, Deggingen (DE)

(21) Appl. No.: 19/121,674

(22) PCT Filed: Oct. 16, 2023
(86) PCT No.: PCT/EP2023/078708

§ 371 Date: Apr. 16, 2025

(30) Foreign Application Priority Data
Oct. 17, 2022 (DE) 10 2022 127 146.3
Oct. 17, 2022 (EP) 22 202 029.9

(51) Int. Cl. B29B 7/72; B29B 7/42

(52) U.S. Cl. CPC B29B 7/728; B29B 7/42

(57) ABSTRACT

Method for operating an extruder comprising at least one screw shaft which is mounted rotatably in a cylinder and is drivable in rotation by a motor, comprising the steps of: detecting a torque signal, which is associated with at least one drive shaft or screw shaft (108); detecting maximum peaks of the torque signal; comparing the detected maximum peak of the torque signal with a specified maximum value for the torque; and adjusting the torque of the at least one screw shaft on the basis of the result of the comparison, and a computer program, a controller, and extruder.

The invention relates to a method for operating an extruder. The invention also relates to a computer program, a controller and an extruder.

Treatment processes on extruders, such as twin-screw extruders, have a very wide range of process limits. These can be, for example, in the area of feeding the starting materials, also referred to as “feeder-limited processes”. Another typical process limitation is the drive power of the extruder, or “torque-limited processes”. Despite the high power densities of modern extruders today, the processing of thermoplastics, such as polyamide (PA) or polybutylene terephthalate (PBT), with fibres such as glass fibres, and other plastics is still limited by the power of the extruder's main drive and/or the mechanical strength of the components. With good product quality, the processes are run in a range from about 75 to 95% of the maximum speed of the extruder. This means that the maximum power of the motor, e.g. asynchronous motor, is almost fully utilised. Top speeds of 95 to 100% of the maximum rotational speed are often not used.

Like all processes, torque-limited processes are also subject to certain fluctuations. These can be caused for example by the dosing system, the material, or also normal fluctuations in the extrusion process. As a result, measured variables such as the screw tip pressure or the torque of the main drive can be subject to certain fluctuation margins. The torque signal in particular reacts very quickly to process fluctuations, as it can be significantly influenced by the amount of material in the melting zone. The torque signal is a signal monitored in the controller that triggers a warning when a threshold value is exceeded (relative to the mechanical design of the system) and triggers an emergency shutdown of the extruder and/or opens the safety clutch in the drivetrain when a maximum value is exceeded to mechanically separate the motor from the screw shafts. However, an emergency shutdown entails extensive cleaning work and other manual interventions that reduce the productivity of the extrusion system, such as a compounding line. In the worst case, permanent machine damage cannot be prevented.

To avoid these emergency shutdowns, the plant operators select a safe operating point at which there is significant separation between the torque level and the maximum value. Typically, the extruders for such processes are operated at 80 to 90% of the maximum torque. Due to uncertainty, plant operators often operate at torque levels that are lower still. However, since plant operators can only read the torque signal at a low sampling rate on the control display, they are unable to recognise the full range of fluctuation of the signal. Plant operators therefore have no chance of receiving reliable data for assessing the actual range of fluctuation, especially in the case of heavily fluctuating processes.

However, it has been found that an optimisation of the operating point towards a higher torque level is not possible in a production-safe manner.

The object underlying the invention is that of structurally and/or functionally improving a method as mentioned in the introduction. A further object of the invention is that of structurally and/or functionally improving a computer program as mentioned in the introduction. Another object of the invention is that of structurally and/or functionally improving a controller as mentioned in the introduction and an extruder as mentioned in the introduction.

Therefore, it is a particular object of the present invention to provide a method for operating an extruder which can reduce or eliminate the problems identified in connection with the prior art. For example, one object is to enable optimisation of the operating point and/or ensure operation at a higher torque level in a production-safe manner.

The object is achieved with a method having the features of claim 1. The object is also achieved with a computer program having the features of claim 16. Moreover, the object is achieved with a controller having the features of claim 17 and an extruder having the features of claim 18. Advantageous embodiments and/or further developments are the subject matter of the subclaims, the description and/or the accompanying figures. In particular, the independent claims of one claim category can also be developed and/or combined similarly to the dependent claims of another claim category. Device and method features as described in the following may also be combined and/or developed further with one another.

A method may be or serve the operation of an extruder. The extruder may have a cylinder. The extruder may have at least one screw shaft, such as an extruder screw. The at least one screw shaft may be mounted rotatably in the cylinder. For example, the extruder may have two screw shafts. The extruder may be a single-screw extruder, multi-shaft extruder or a twin-screw extruder. The extruder may have a motor. The at least one screw shaft may be driven in rotation. The at least one screw shaft may be driven rotationally or be or be made drivable in rotation by the motor. The extruder may have at least one drive shaft. The at least one drive shaft may be coupled or capable of being coupled to the at least one screw shaft. The extruder may have a frequency converter. The frequency converter may be coupled to the motor. The extruder may have at least one measuring device for detecting a torque, for example an applied torque. The at least one measuring device may have a corresponding sensor system for this purpose. The torque may be the torque of the at least one drive shaft or the at least one screw shaft. The torque may be scanned or measured by means of the at least one measuring device. For example, the at least one measuring device may scan or measure the torque of only one drive shaft or screw shaft. Alternatively, the at least one measuring device may scan or measure the torque of two or all drive or screw shafts. Each drive shaft or each screw shaft may also be assigned a measuring device. Additionally or alternatively, the at least one measuring device may detect the torque of the drivetrain and/or on a clutch or clutch sleeve.

The method may include the step of: detecting a torque signal. The torque signal may be assigned to the at least one drive shaft or the at least one screw shaft and/or the coupling/coupling sleeve and/or the drivetrain. The torque signal may be or have been provided as a signal from the frequency converter. The torque signal may be or have been provided as a measurement signal from the at least one drive shaft or the at least one screw shaft. The torque signal may be or have been provided by the at least one measuring device for detecting the torque. The torque signal may be or have been detected and/or provided continuously. The torque signal may be or have been composed of several torque signals, e.g. summed, for example from a first torque signal from a first drive or screw shaft and a second torque signal from a second drive or screw shaft.

The method may include the step of: detecting maximum peaks of the torque signal, in particular the one detected. Maximum peaks may be, in particular, maximum and/or significant peak values. It may also be provided that at least one maximum peak of the torque signal is detected. The detected torque signal may be analysed with regard to maximum peaks, in particular over a defined time interval.

The method may include the step of: comparing the detected maximum peaks of the torque signal with a specified maximum value for the torque. It may also be provided that the at least one maximum peak of the torque signal is compared with the specified maximum value for the torque. The maximum value for the torque may be a maximum permissible torque. The maximum value for the torque may be a set and/or calculated maximum value. For example, the maximum value for the torque may be set, defined and/or calculated, in particular by a controller, such as extruder controller. The setting, definition and/or calculation of the maximum value for the torque may be done automatically. The maximum value for the torque may be or have been set, defined, calculated and/or limited accordingly based on at least one process signal and/or process parameter. A process signal and/or process parameter may be, for example, a discharge pressure or a temperature, such as material temperature or barrel temperature. Additionally or alternatively, the maximum value for the torque may be recipe-dependent or may be or have been set, defined, calculated and/or limited depending on the recipe. Additionally or alternatively, other values, such as boundary values for process parameters may be recipe-dependent or may be or have been set, defined, calculated and/or limited depending on the recipe. The maximum value for the torque may be a value below a switchoff value, such as an emergency switchoff value. For example, the maximum value for the torque may be about 5% below the switchoff value.

The method may include the step of: adjusting the torque of the at least one screw shaft based on the result of the comparison. The adjustment of the torque of the at least one screw shaft may be done automatically, semi-automatically or manually. The automatic or semi-automatic adjustment of the torque may be carried out by a controller, such as an extruder controller. Additionally or alternatively, information or a signal may also be output so that a system operator can adjust the torque manually, for example by setting or changing certain process parameters. The information or signal output may be a recommended course of action for the system operator.

Adjustment may be understood to be a reduction or increase in the torque of the screw shaft. The torque of the at least one screw shaft may be increased if the detected maximum peaks of the torque are below the specified maximum value for the torque. The torque of the screw shaft can be increased by increasing the throughput and/or reducing the speed. Increasing throughput may be understood to mean the addition or increased addition of material, such as plastic material and/or additives. Reducing speed may be understood to mean reducing the speed of the at least one screw shaft and/or the at least one drive shaft. The torque of the at least one screw shaft can be reduced if the detected maximum peaks of the torque reach or exceed the specified maximum value for the torque. The torque of the screw shaft can be reduced by reducing throughput and/or increasing speed. Reducing throughput may be understood to mean reducing the addition of material, such as plastic material and/or additives. Increasing speed may be understood to mean increasing the speed of the at least one screw shaft and/or the at least one drive shaft. The material metering and/or the speed of the at least one drive shaft and/or screw shaft may be influenced, for example if the detected maximum peaks of the torque are below and/or above the specified maximum value for the torque.

In the method, a torque reference value may be or have been provided or specified. The torque reference value may be or have been defined or calculated beforehand. The torque reference value may be or define a baseline. A time interval may be or have been defined. The torque reference value may be or have been calculated continuously for a defined time interval during operation of the extruder and/or based on historical data. The historical data may have been determined under comparable conditions, such as recipe, screw configuration, etc. A fluctuation range around the torque reference value may be analysed and/or determined. The fluctuation range may be a fluctuation range of the torque or the torque signal. The fluctuation range may be analysed and/or determined in the defined time interval. A standard fluctuation range of the torque or torque signal may be or have been defined or determined based on existing or detected data, for example at corresponding operating points of the extruder, recipes or processes. A learning process may be performed using the existing or detected data, for example to define the standard fluctuation range at corresponding operating points, depending on the recipe and/or process (e.g., screw configuration, side feeding and/or degassing, etc.). The maximum peaks of the torque signal may be detected and/or determined based on the analysis of the fluctuation range and/or standard fluctuation range.

A median value or mean value of the torque or torque signal may be calculated for a defined time interval. This can be done based on the detected torque signal and/or retrospectively based on a certain time interval, in particular in the past, such as the immediate past. Calculation of the median value or mean value of the torque or torque signal for a defined time interval is done continuously during operation of the extruder and/or based on historical data. The torque reference value may be the calculated median or mean value. The range of fluctuation can be analysed and/or determined in the defined time interval around the calculated median or mean value. Including the median or mean value enables a more reliable calculation and/or analysis. This in turn allows a more precise throughput adjustment and/or speed adjustment to be made.

The steps such as detecting the torque signal, detecting maximum peaks of the torque signal, comparing the detected maximum peaks of the torque signal with the specified maximum value for the torque and adjusting the torque of the at least one screw shaft based on the result of the comparison may be carried out repeatedly after each adjustment of the torque of the at least one screw shaft, in particular until the respectively detected maximum peaks of the torque have reached or substantially reached the specified maximum value for the torque. These steps may also be carried out repeatedly after each increase in throughput and/or reduction in speed until the respectively detected maximum torque peaks have reached or substantially reached the specified maximum torque value.

In the method, an occurrence influencing the torque and/or a process signal associated with this occurrence may be detected and/or captured. A previously planned or currently performed adjustment of the torque of the at least one screw shaft may be stopped at least temporarily if an occurrence influencing the torque and/or a process signal associated with this occurrence has been detected or captured. A temporary or short-term adjustment of the torque of the at least one screw shaft may be carried out, for example if an occurrence influencing the torque and/or a process signal associated with this occurrence has been recognised or captured. An occurrence influencing the torque may be understood to be, for example, a change in the material temperature, for example in the feed, a material feeder, a refill or a dosing. A change in the material temperature may be understood to be an increase or a decrease in the material temperature. A temporary or short-term adjustment may be understood to be a temporary or short-term reduction or increase in the torque of the at least one screw shaft. The torque of the at least one screw shaft can be set back to the previous value, such as the original value or initial value, after the occurrence influencing the torque has ended. Process signals may be used to influence the process in targeted manner in the short term, in particular to reduce the torque peaks. In this way, foreseeable short-term effects cannot lead to the permissible torque signal or maximum value being exceeded. For example, the speed of the at least one screw shaft can be adjusted briefly during the refilling of a dosage to avoid a peak that would lead to the maximum permissible torque signal or maximum value being exceeded.

In the method, the adjustment of the torque of the at least one screw shaft may be stopped if the maximum peaks of the torque have reached or substantially reached the specified maximum value for the torque. The fluctuation range can be analysed continuously and/or the torque of the at least one screw shaft can be adjusted as required during operation of the extruder, for example by increasing or decreasing throughput and/or increasing or decreasing speed.

The detection of the torque signal and/or the adjustment of the torque of the at least one screw shaft may take place in real time. The torque signal and/or the process signals and/or data can be processed in real time, for example with a controller such as an extruder controller.

A computer program may be a software product. The computer program may be a computer program component or at least include a computer program component. The computer program may cause a controller, such as an extruder controller, and/or a control and/or computing unit/device, a control system and/or an extruder and/or a processor or a computer to carry out the method described previously and/or in the following. For this purpose, the computer program may have corresponding data records and/or program code means and/or a storage medium for storing the data records and the program. The computer program or computer program component may be stored on a computer-readable medium, such as a storage medium.

The computer program may comprise program code means and/or commands for carrying out the method described previously and/or in the following when the computer program is run on at least one processor. The computer program/computer program component may comprise program code means and/or commands for carrying out at least one of the steps of the method described previously and/or in the following or which cause a controller, such as an extruder controller or an extruder, to carry out at least one of the steps of the method described previously and/or in the following when the computer program is run on at least one processor.

For example, the computer program or a first computer program/a first computer program component may comprise program code means and/or commands for carrying out the steps of detecting the torque signal, detecting maximum peaks of the torque signal, and comparing the detected maximum peaks of the torque signal with the specified maximum value for the torque of the method described previously and/or in the following when the computer program/the computer program component is run on at least a first processor or computer, or which cause a controller, such as an extruder controller or an extruder, to carry out these steps. The first computer program/the first computer program component may comprise program code means and/or commands to cause the at least one first processor and/or computer to send data to and/or receive data from a second processor and/or computer when the computer program/computer program component is run on the at least one first processor and/or computer.

Additionally or alternatively, the computer program or the first computer program/computer program component may comprise program code means and/or commands for evaluating historical data and/or signals when the computer program/computer program component is run on at least one first processor or computer. Historical data and/or signals may be understood to be data or signals that have been captured previously at comparable operating points, processes and/or recipes.

The computer program or a second computer program/a second computer program component may comprise program code means and/or commands for carrying out the step of adjusting the torque of the at least one screw shaft based on the result of the comparison of the method described previously and/or in the following when the computer program/the computer program component is run on at least one second processor and/or computer, or which cause a controller, such as an extruder controller or an extruder, to carry out this step. The second computer program/second computer program component may comprise program code means and/or commands to cause the at least one second processor and/or computer to send data to the first processor and/or computer and/or to receive data therefrom when the computer program/computer program component is run on the at least one second processor and/or computer.

Additionally or alternatively, the computer program or the first and/or second computer program/computer program component may comprise program code means and/or commands for evaluating current data and/or signals, in real time for example, when the computer program/computer program component is run on at least one first processor or computer.

A distributed computer environment/processor environment may be established. For example, a networked client-server system, peer-to-peer network and/or a cloud, such as a computer cloud, may be provided. Parts of the computer program may be provided either centrally or in decentralised manner. For example, the second computer program/the second computer program component may be carried out by means of a controller, such as an extruder controller. The first computer program/the first computer program component may be carried out by means of a controller, such as an extruder controller, and/or carried out by means of an external evaluation unit or carried out by means of a computer cloud or in a cloud. The external evaluation unit may be connected to the controller. The controller, such as the extruder controller, may be connected to the cloud or computer cloud, for example wired or wirelessly. For this purpose, the controller may contain a corresponding transmitting and/or receiving device.

A controller for an extruder may be an extruder controller. The controller may be a control device. The controller may be set up and/or intended for use in an extruder or extruder system. The controller may be set up and/or intended to carry out the method described previously and/or in the following. The controller may include at least one processor and/or computer, such as a microcomputer, and/or the computer program and/or at least one computer program component. The controller may include a computer-readable memory, such as storage medium. The computer program or computer program component may be stored in the memory. The controller may include a transmitting and/or receiving device. The controller may be designed and/or configured to be connected to an external storage medium or external processor or computer and/or cloud, such as a computer cloud. The controller may have at least one measuring device for detecting the torque of the at least one screw shaft and/or the at least one drive shaft or may be connected thereto. The controller may have a frequency converter or may be connected thereto. The controller may be designed and/or configured to communicate with the at least one measuring device and/or with the frequency converter and/or to exchange data, such as signals therewith.

An extruder may be designed for processing material, such as plastic material. The extruder may have a cylinder, such as an extruder cylinder. The extruder may have at least one screw shaft, such as an extruder screw. The at least one screw shaft may be mounted rotatably in the cylinder. The at least one screw shaft may be rotationally drivable. The extruder may have two screw shafts, for example. The extruder may be a single-screw extruder, multi-shaft extruder or a twin-screw extruder. The extruder may have a motor. The at least one screw shaft may be drivable rotationally by the motor or may be or be made drivable in rotation. The extruder may have at least one drive shaft. The at least one drive shaft may be coupled or capable of being coupled to the at least one screw shaft. The extruder may have a frequency converter. The frequency converter may be coupled to the motor. The extruder may have at least one measuring device for detecting a torque of the at least one screw shaft or the at least one drive shaft. The at least one measuring device may have a corresponding sensor system for this purpose. The at least one measuring device may be designed to scan and/or measure the torque. For example, the at least one measuring device may be designed to scan and/or measure the torque of only one drive or screw shaft. Alternatively, the at least one measuring device may be designed to scan and/or measure the torque of two or all drive or screw shafts. Each drive shaft or each screw shaft may be assigned a measuring device. Additionally or alternatively, the at least one measuring device may be designed to detect the torque of the drivetrain and/or on a coupling or coupling sleeve. The extruder may be configured and/or intended to carry out the method described previously and/or in the following. The extruder may have a controller, such as an extruder controller. The controller may be designed as described previously and/or in the following. The controller may be designed and/or configured to communicate with the at least one measuring device and/or with the frequency converter and/or to exchange data, such as signals therewith.

In summary and in other words, the invention thus provides, among other things, an algorithm, such as a method, for evaluating existing and captured signals, for example process signals for torque, speed, pressure, temperature, and/or throughput, etc., of the extruder, e.g. twin-screw extruder. An adjustment of the operating point derived therefrom may then be made, for example an adjustment of the speed, throughput and/or barrel temperature control, etc., to obtain a greater torque. The algorithm can be trained using existing data from the system, for example in order to define a standard fluctuation range at corresponding operating points, depending on the recipe and/or the process (screw configuration, side feeds, degassing, etc.). The algorithm may form or determine the median value or mean value, of the torque signal continuously during operation of the extruder, as a baseline for example, referring back to a certain time interval in the past. The algorithm may use historical data for the calculation, for example if such data was generated under comparable conditions (recipe, screw configuration, etc.). In the time interval, the fluctuation range around the median value or mean value (e.g. the baseline) can be analysed to record the maximum peaks of the torque signal. If these peaks are below a set maximum value for the maximum permissible torque, the algorithm may increase the throughput of the extruder automatically, semi-automatically or with a required user input, for example in very small increments of about 1% of the total throughput, or according to a defined calculation model. The throughput increase may be linear or non-linear. The basis for the throughput increase may be the dependence of the process influencing variables on the torque, determined for example by the algorithm. A specified, e.g. set, maximum value does not have to be the value for the emergency shutdown of the extruder, but a value that is below the shutdown value with a certain degree of certainty, e.g. about 5% below. The measurement signals, the median value and/or mean value/baseline, the fluctuation range of the measurement signal, and/or the peaks that occur, etc. can be evaluated again after each throughput adjustment. The process parameters, such as the torque, can be adjusted again on the basis of the new findings. This allows the median value and/or mean value (such as the baseline) of the torque signal to be increased constantly until the maximum peaks of the torque signal reach the permissible or specified maximum value. The throughput increase can then be stopped. The algorithm may continue to analyse the fluctuation range of the torque signal during operation and/or adjust the throughput as necessary. If the fluctuation range in the process increases, the throughput can be reduced, e.g. to avoid the risk of an emergency shutdown. The steps for reducing the throughput may be performed similarly to those for increasing the throughput and/or based on historical data or a mathematical calculation model. In some processes, the maximum throughput may be or may become limited by peripheral devices, such as dosing or discharge units. An increase in throughput to optimise the torque may therefore not always be possible at all times. As an alternative to increasing the throughput, the speed of the extruder and/or the screw shaft(s) might also be reduced while maintaining the same throughput in order to increase the torque and/or maximise it. This can lead to a reduction of the specific energy input. Particularly for extruders in the large machine sector, this can result in significant cost savings per kg. of produced product. In order to make the algorithm more efficient, robust and/or more proactive, other signals from the process chain, such as signals from the dosing system, may be or may have been integrated in the analysis. This means that potential influences on the torque signal can be recognised before they have an impact, and/or the operating point can be adjusted accordingly. The algorithm may be or may have been implemented on the controller, such as the extruder controller. The data can be processed in real time. The algorithm can thus use data in real time and/or with a higher resolution. Additionally or alternatively, a combined calculation may be provided, wherein historical data/signals are evaluated on an external evaluation unit or a cloud, and only the current data/signals and the adjustment are captured and/or calculated and evaluated on the controller or by means of the controller.

The invention enables the torque to be optimised. The operating point at the torque limit can be optimised. Productivity can thus be increased. The maximum permissible torque and the associated throughput maximisation can be utilised in a reliable operating state, for example automatically or semi-automatically or manually, on existing extruders, for example. Better product quality often follows naturally as a result of optimising the torque, whether by increasing throughput or reducing the speed, because the product can be processed more gently.

In the following, embodiments of the invention are described in greater detail with reference to figures, which show schematically and for exemplary purposes:

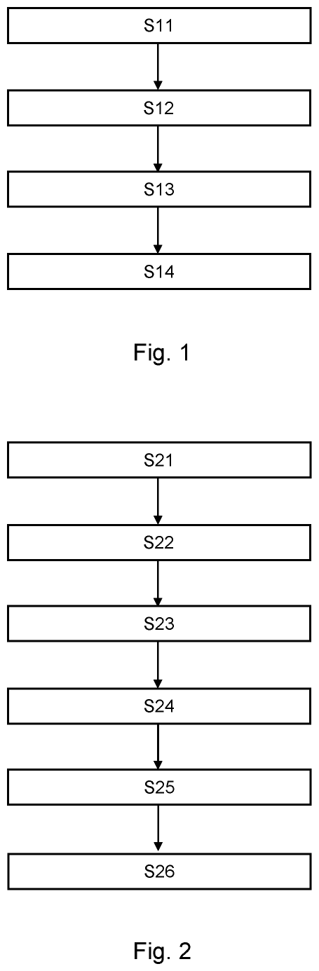

FIG. 1 a flow chart for a variant of a method for operating an extruder;

FIG. 2 a flow chart for a further variant of a method for operating an extruder; and

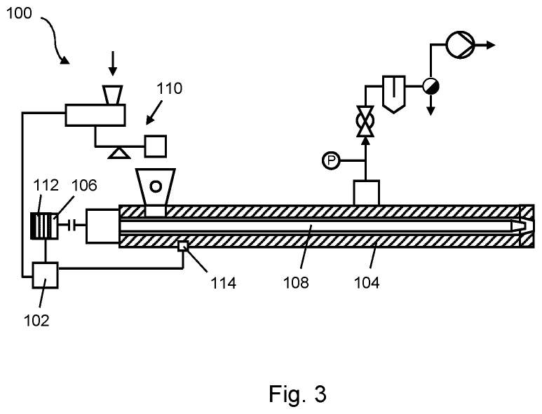

FIG. 3 an extruder with a controller.

FIG. 1 shows a schematic flow chart for a variant of a method for operating an extruder.

The extruder comprises at least one screw shaft that is mounted rotatably in a cylinder and can be driven in rotation by a motor. The at least one screw shaft is coupled to at least one drive shaft. The at least one drive shaft is coupled to the motor.

In a step S11, a torque signal is detected which is associated with the at least one drive or screw shaft. The torque signal thus corresponds to the torque of the at least one drive or screw shaft. The torque signal may, for example, originate from a frequency converter or may be or have been provided by at least one measuring device for detecting the torque.

In a step S12, maximum peaks of the torque signal are detected, and in a step S13 the detected maximum peaks of the torque signal are compared with a specified maximum value for the torque.

In a step S14, the torque of the at least one screw shaft is adjusted based on the result of the comparison. The torque of the at least one screw shaft may be adjusted automatically, semi-automatically or manually. The torque of the at least one screw shaft may be increased if the maximum torque peaks detected are below the specified maximum value for the torque. The torque of the at least one screw shaft may be increased by increasing the throughput and/or reducing the speed. After each adjustment of the torque of the at least one screw shaft and/or after each increase in the throughput and/or reduction of speed, steps S11 to S14 can be carried out repeatedly until the maximum peaks of the torque detected in each case have reached or substantially reached the specified maximum value for the torque. The adjustment of the torque of the at least one screw shaft can be stopped when the maximum peaks of the torque have reached or substantially reached the specified maximum value for the torque.

FIG. 2 shows a schematic flow chart for a further variant of a method for operating an extruder. The extruder comprises at least one screw shaft which is mounted rotatably in a cylinder and can be driven in rotation by a motor. The at least one screw shaft is coupled to at least one drive shaft. The at least one drive shaft is coupled to the motor.

In a step S21, a torque signal is detected which is associated with the at least one drive or screw shaft. The torque signal thus corresponds to the torque of the at least one drive or screw shaft. The torque signal may, for example, originate from a frequency converter or be provided by at least one measuring device for detecting the torque.

In a step S22, a torque reference value is provided. In this case, a median value or mean value of the detected torque or torque signal can be calculated for a defined time interval. The torque reference value is then the calculated median value or mean value.

In a step S23, a fluctuation range around the torque reference value is analysed, and in a step S24, maximum peaks of the torque signal are detected based on the analysis of the fluctuation range.

In a step S25, the detected maximum peaks of the torque signal are then compared with a specified maximum value for the torque.

In a step S26, the torque of the at least one screw shaft is adjusted based on the result of the comparison. The torque of the at least one screw shaft may be adjusted automatically, semi-automatically or manually. The torque of the at least one screw shaft can be increased if the detected maximum peaks of the torque are below the specified maximum value for the torque. The torque of the at least one screw shaft can be increased by increasing the throughput and/or reducing the speed. Steps S21 to S26 can be carried out repeatedly after each adjustment of the torque of the at least one screw shaft or after each increase in throughput and/or reduction in speed, until the maximum peaks of the torque detected in each case have reached or substantially reached the specified maximum value for the torque. The adjustment of the torque of the at least one screw shaft can then be stopped when the maximum peaks of the torque have reached or substantially reached the specified maximum value for the torque.

Otherwise, reference is made in particular to FIG. 1 and the associated description.

FIG. 3 shows a schematic representation of an extruder 100 with a controller 102. The extruder comprises a cylinder 104 and at least one screw shaft 108 which is mounted rotatably in the cylinder 104 and can be driven in rotation by a motor 106. The at least one screw shaft 108 is coupled to at least one drive shaft, which is coupled to the motor 106. In the present embodiment, the extruder is designed as a twin-screw extruder and has two rotatably drivable screw shafts 108 which are mounted rotatably in the cylinder 104. In addition, a material metering device 110 is provided in order to feed material, e.g. plastic material, to the extruder and screw shafts 108.

The controller may be connected to a frequency converter 112 and/or a measuring device 114 or communicate with them and exchange data and/or signals therewith. The frequency converter 112 may provide the controller 102 with a torque signal assigned to at least one drive shaft or screw shaft 108. The measuring device 114 is designed to detect and measure a torque from at least one or both screw shafts 108 and to provide the associated torque signal to the controller 102. The controller 102 and/or the extruder 100 is designed and/or intended to carry out the method described previously and/or in the following.

Otherwise, reference is made in particular to FIGS. 1 and 2 and the associated description.

The term “may” refers in particular to optional features of the invention. Accordingly, there are also further developments and/or embodiments of the invention which additionally or alternatively have the respective feature or features.

If necessary, separate features may also be selected from the combinations of features disclosed here and used in combination with other features to delimit the subject matter of the claim, dissolving any structural and/or functional connection that may exist between the features. The order and/or number of steps of the method can be varied.

### REFERENCE NUMERALS

S11 Step for detecting a torque signal
S12 Step for detecting maximum peaks of the torque signal
S13 Step for comparing the maximum peaks of the torque signal with a specified maximum value for the torque
S14 Step for adjusting the torque of the at least one screw shaft
S21 Step for detecting a torque signal
S22 Step for providing a torque reference value
S23 Step for analysing a fluctuation range around the torque reference value
S24 Step for detecting maximum peaks of the torque signal
S25 Step for comparing the maximum peaks of the torque signal with a specified maximum value for the torque
S26 Step for adjusting the torque of the at least one screw shaft
100 Extruder
102 Controller
104 Cylinder
106 Motor
108 Screw shaft
110 Material metering
112 Frequency converter
114 Measuring device

1. A method for operating an extruder comprising at least one screw shaft mounted rotatably in a cylinder and drivable in rotation by a motor, the method comprising:
detecting a torque signal which is assigned to at least one drive or the at least one screw shaft (108);
detecting maximum peaks of the torque signal;
comparing the detected maximum peaks of the torque signal with a specified maximum value for the torque; and
adjusting the torque of the at least one screw shaft based on the comparison.

2. The method according to claim 1, wherein the torque of the at least one screw shaft is increased if the detected maximum peaks of the torque are below the specified maximum value for the torque.

3. The method according to claim 1, wherein the torque of the at least one screw shaft is increased by means of increasing a throughput and/or reducing a speed, or that the torque of the at least one screw shaft is reduced by means of reducing the throughput and/or increasing the speed.

4. The method according to claim 1, wherein a torque reference value is provided, a fluctuation range around the torque reference value is analysed, and the maximum peaks of the torque signal are detected based on the analysis of the fluctuation range.

5. The method according to claim 4, wherein a median value or mean value of the torque or torque signal is calculated for a defined time interval and the torque reference value is the calculated median value or mean value.

6. The method according to claim 5, wherein the calculation of the median value or mean value of the torque or torque signal is carried out continuously for a defined time interval during operation of the extruder and/or based on historical data.

7. The method according to claim 1, wherein the specified maximum value for the torque is or has been set, defined, calculated and/or limited based on at least one process signal or process parameter and/or depending on a recipe.

8. The method according to claim 1, wherein after each adjustment of the torque of the at least one screw shaft, the steps are carried out repeatedly until the respectively detected maximum peaks of the torque have substantially reached the specified maximum value for the torque.

9. The method according to claim 1, wherein an occurrence influencing the torque and/or a process signal associated with this occurrence is detected, and a temporary adjustment of the torque of the at least one screw shaft takes place when an occurrence influencing the torque and/or a process signal associated with this occurrence has been detected and/or captured.

10. The method according to claim 9, wherein a previously planned or currently in progress adjustment of the torque of the at least one screw shaft is stopped at least temporarily if an occurrence influencing the torque and/or a process signal associated with this occurrence has been detected or captured.

11. The method according to claim 1, wherein a standard fluctuation range of the torque is defined based on existing or captured data, in particular at corresponding operating points of the extruder, recipes or processes.

12. The method according to claim 1, wherein the torque of the at least one screw shaft is adjusted automatically, semi-automatically or manually.

13. The method according to claim 1, wherein the adjustment of the torque of the at least one screw shaft is stopped when the maximum peaks of the torque have substantially reached the specified maximum value for the torque.

14. The method according to claim 1, wherein the fluctuation range is analysed continuously during operation of the extruder, and the torque of the at least one screw shaft is adjusted as necessary, in particular by means of increasing or reducing throughput and/or increasing or reducing speed.

15. The method according to claim 1, wherein the detection of the torque signal and/or the adjustment of the torque of the at least one screw shaft takes place in real time and/or that the torque signal and/or the process signals and/or data are processed in real time, in particular with a controller, such as an extruder controller.

16. A non-transitory computer-readable medium storing instructions that, when executed by one or more processors, cause the one or more processors to control a controller and/or the extruder to perform the method according to claim 1.

17. A controller for an extruder, the controller comprising:
at least one processor; and
a non-transitory computer-readable medium storing instructions,
wherein the at least one processor is configured to execute the instructions to perform the steps of:
detecting a torque signal which is assigned to at least one drive or at least one screw shaft;
detecting maximum peaks of the torque signal,
comparing the detected maximum peaks of the torque signal with a specified maximum value for the torque, and
adjusting the torque of the at least one screw shaft based on the comparison.

18. An extruder comprising:
a cylinder,
at least one screw shaft mounted rotatably in the cylinder and drivable in rotation by a motor,
wherein the extruder is configured to perform the steps of:
detecting a torque signal which is assigned to at least one drive or the at least one screw shaft;
detecting maximum peaks of the torque signal,
comparing the detected maximum peaks of the torque signal with a specified maximum value for the torque, and
adjusting the torque of the at least one screw shaft based on the comparison.
